(19) United States
(12) Patent Application Publication
(10) Pub. No.: US 2006/0060280 A1
(43) Pub. Date: Mar. 23, 2006

(54) Non-pneumatic flexible tire

(75) Inventors: Jean-Pierre Ladouce, Clermont-Ferrand (FR); Daniel Laurent, Marly (CH)

Correspondence Address: COHEN, PONTANI, LIEBERMAN & PAVANE, 551 FIFTH AVENUE, SUITE 1210, NEW YORK, NY, 10176, US

(73) Assignee: Conception et Developpement Michelin S.A., Givisiez (CH)

(21) Appl. No.: 11/224,763

(22) Filed: Sep. 13, 2005

(30) Foreign Application Priority Data
Sep. 23, 2004 (FR) 04/10082

(51) Int. Cl. B60C 7/24

(52) U.S. Cl. 152/375

(57) ABSTRACT

The tire 1 comprises a plurality of support elements 2 connected to an interconnection structure 3 to a tread 4, each support element being connected by a staple 7 to a wheel disk 6.

This invention relates to tires mounted on wheels and designed to carry a substantial load without any inflation pressure, hence the name non-pneumatic tires.

Patent application WO 00/37269 divulges such a non-pneumatic elastic tire. It describes a load bearing structure composed essentially of a plurality of support elements distributed essentially radially with cyclic symmetry around the entire circumference of the tire. When the tire described in patent application WO 00/37269 supports a load, a number of support elements present in the contact area are subjected to strong bending, so that they develop a force resisting part of the load. An interconnection structure makes all support elements work together, transferring forces to adjacent support elements. Therefore the capacity of this tire to support a given load is due to the bending force applied on support elements present in the contact area of the non-pneumatic elastic tire, and also due to the bending force in support elements outside the contact area of the non-pneumatic elastic tire through the interconnection structure.

Patent application EP 1 359 028 proposes a tire of this type for which the interconnection structure is connected to the support elements through elastic joints.

The present invention relates particularly to the connection of support elements with the wheel disk.

One purpose of the invention is to propose a simple, precise and reliable connection compatible with industrial assembly of flexible tires.

The invention proposes a flexible tire with a flexible load bearing structure extending circumferentially around a rotation axis, a tread at the periphery radially outside the load bearing structure, and at least one attachment zone radially on the side of the rotation axis, to fix the said load bearing structure to a wheel disk, the load bearing structure comprising a plurality of support elements extending essentially in the transverse direction, in which at least a first part is arranged facing a part of the tread, and another part of which is arranged beyond the tread, the said load bearing elements being adjacent to each other around the circumferential direction and distributed all around the circumference, each load bearing element being fixed on the wheel disk by a staple, the said staple straddling the support element and being designed to cooperate with wheel attachment means.

The invention also relates to a support element for a flexible tire, the said tire comprising a plurality of support elements adjacent to each other circumferentially and distributed all around a rotation axis of the tire to form a load bearing structure, a tread at the radially outside periphery of the load bearing structure, a staple being fixed to the said support element and designed to cooperate with the wheel disk attachment means.

The staple preferably consists of a metal plate folded to match the shape of the attachment zone of the said support element.

The support element preferably comprises a stack of flexible strips and layers of a polymeric composition. Also preferably, the flexible strips have a closed ovoid shape. The staple is preferably fixed to the said support element through the said polymeric composition.

The staple preferably comprises two arms extending radially inwards into the tire and a filling occupies the volume between the arms of the staple under the section of the support element. The arms are preferably dovetailed in shape.

The invention also relates to a wheel disk capable of connecting the tire according to the invention to a hub, the said disk comprising attachment means capable of cooperating with a plurality of staples to fix a plurality of support elements. Attachment means preferably include a cylindrical bearing surface, a circumferential shoulder and a tightening ring capable of cooperating to form a dovetail-shaped groove at the periphery of the disk.

The invention also relates to a method of obtaining support elements.

The invention is described in more detail with reference to the following Figures, in which:

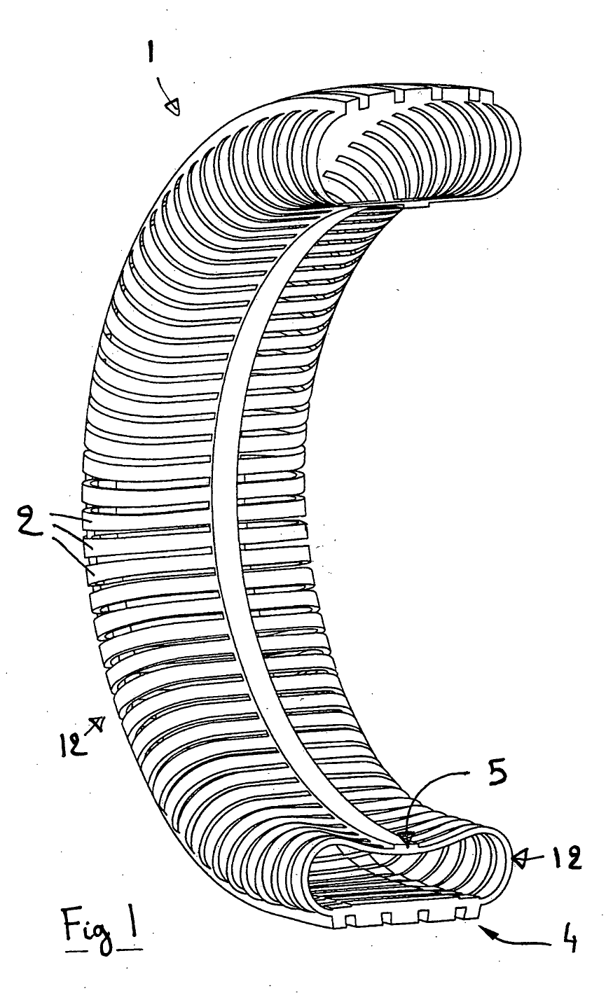

FIG. 1 is a partial perspective view of the non-pneumatic tire,

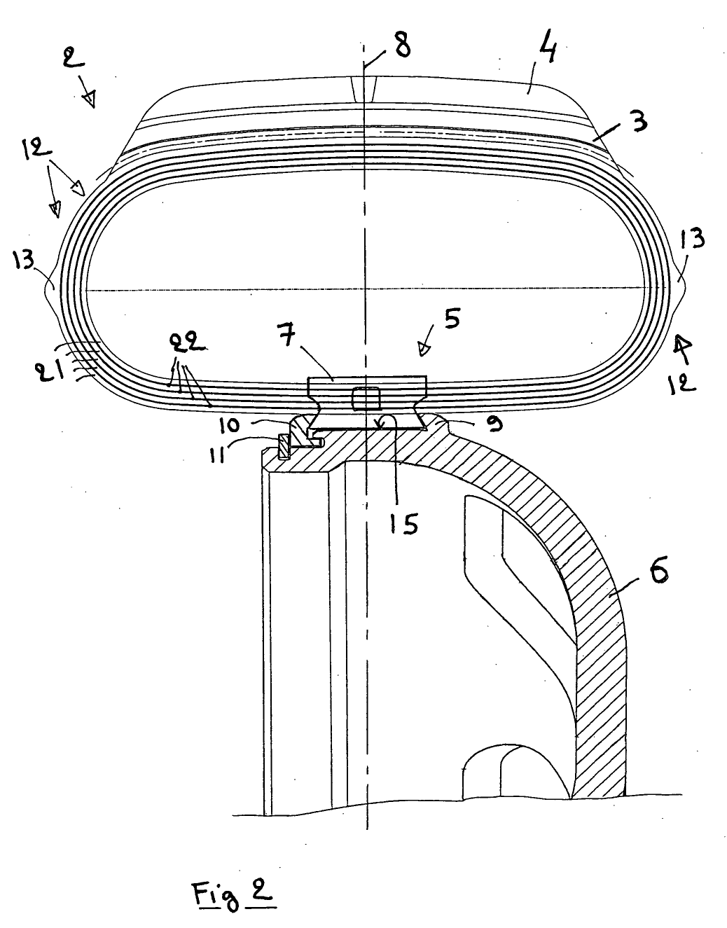

FIG. 2 is a partial section through a complete wheel according to the invention,

FIG. 3 is a perspective view of a section through the wheel disk according to the invention,

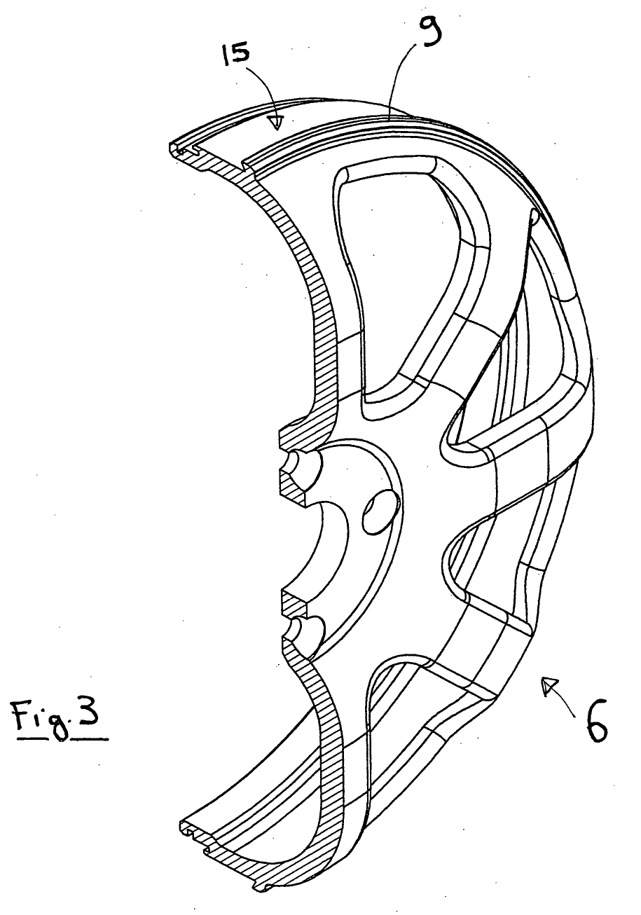

FIG. 4 is a plane view of the attachment zone according to the invention,

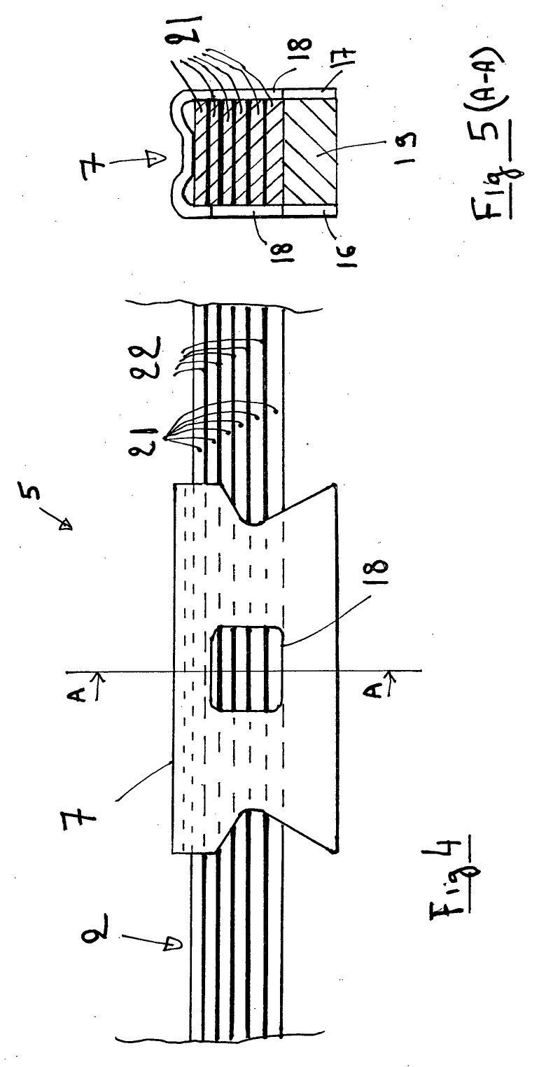

FIG. 5 is a sectional view along plane A-A in FIG. 4,

FIG. 6 is an enlargement of the central part in FIG. 2.

FIG. 1 shows the general shape of a flexible tire 1 according to the invention. When such a tire is associated with a wheel disk or any other mechanical device designed to form the connection between the flexible tire and the hub, the tire replaces the assembly composed of the tire and the wheel as we know it on most passenger cars in the current market. The tire profile delimits an ovoid shaped toroidal internal cavity. The tire 1 comprises an attachment zone 5, two sidewalls 12 and a tread 4. In FIG. 1, the tread 4 comprises several parallel ribs, but obviously this is not in any way limitative. The sidewalls 12 are rounded and occupy most of the radial height of the tire 1. The load bearing structure comprises a plurality of support elements 2. The support elements 2 are circumferentially adjacent and each extends essentially in the radial direction starting from the attachment zone 5. FIG. 1 also shows the principle of this type of non-pneumatic tire in which the load is supported by bending of the support elements.

FIG. 2 shows a preferred embodiment. The support elements 2 comprise a stack of flexible strips 21 made of a composite material, radially superposed with insertion of a layer 22 of polymer or a polymer composition, and particularly dienic or polyurethane elastomer, between the strips 21. The connection between the composite material and the said polymer is obtained in a known manner, particularly during the baking operation, or during polymerisation or final cross linking of the assembly, if necessary using an adhesive composition adapted to the nature of the polymer, for example as described in patent WO 04/058909.

A mechanical preparation (for example by grinding) and/or a chemical preparation (for example by using an acid) of the surface of the strips can be helpful in improving the connection between the strips 21 and the layer 22.

The bundle of strips thus glued to each other forms a beam capable of resisting mainly bending forces. Each flexible strip 21 preferably extends all around the section of the tire without interruption. In this case the stack represented contains 5 strips. However, this composition of the laminate is not limitative.

Other details about the composition of these support elements and the interconnection structure can be found in patent applications WO 00/037269 and EP 1 359 028 mentioned above.

We will simply recall that the composite material of the strips 21 comprises reinforcing fibres embedded in a resin. A thermosetting resin will be used in preference, but a thermoplastic resin may be suitable in some applications in which the forces to be resisted are lower. Most fibres are preferably arranged longitudinally in each strip. For example, glass fibres may be used. Obviously, many other fibres could be used, for example such as carbon fibres. A hybrid prepared with different natures of fibres could also be used.

The term “attachment zone” is used to denote the part of the tire in general that will cooperate with a rigid mechanical part, also fixed to a hub. We will use the term “wheel disk” to denote the said rigid mechanical part.

FIG. 2 shows a preferred embodiment of the invention. In this embodiment, the support elements 2 are closed and comprise a single attachment zone 5. The attachment zone 5 is rigidly fixed to the wheel disk 6. In this example, the attachment zone is axially centred with respect to the tire (see position of staple 7 with respect to the median plane 8 of the wheel). The tire 1 comprises a large number of support elements as shown in FIG. 1.

The tire sidewalls 12 are provided with protective swellings composed of a polymer similar to the polymer in layer 22 which is placed between the flexible strips 21. The tread 4 is connected to all support elements through an interconnection structure 3.

Each support element 2 is connected to the wheel disk 6 through a staple 7. Attachment means fix the staple in position with respect to the disk in the radial, axial and circumferential directions. Preferably, the attachment means comprise a cylindrical bearing surface 15 on the disk, an inclined circumferential shoulder 9 fixed to the disk 6, a clamping ring 10 and an elastic locking ring 11. Therefore, the staples 7 (one for each support element 2) are stacked along the circumference of the disk. Preferably, the number of support elements (and therefore the number of staples) is such that the staples bear in contact with each other in the circumferential direction. Alternately, a given space may be provided between the staples, and this space may or may not be filled with spacers to maintain a circumferential pressure on the staples.

FIG. 3 shows the wheel disk 6. In this case it is in the general shape of a conventional wheel except for its radially external part on which the tire according to the invention will be fitted, this particular external part replacing the rim of a conventional wheel. Naturally, this is only one example provided to illustrate the essential function of the wheel disk that is to provide a mechanical connection with the hub. Therefore this wheel disk may be of any appropriate shape, for example a single-piece as shown on this example, or conversely it may be assembled from several parts.

FIGS. 4 and 5 show a method of making the staple 7 in FIG. 2 in more detail, and its connection to a support element. This staple is preferably composed of a metal plate cut and folded so as to match the section of the support element in the attachment zone. The staple is preferably made of steel plate. The shape of the two arms 16 and 17 of the staple that project radially inwards into the tire 1 from the said section, enables efficient rigid fixing. A dovetail shape as shown herein is an example of one possible shape and is known in itself. The section in FIG. 5 clearly shows that the flexible strips 21 and the intermediate layers 22 are superposed. It can also be seen that the volume between the arms of the staple and under the section of the support element, can be filled in with a filling 19. This filling can preferably be made using the same polymer as the intermediate layers 22. It could also be made from a lightweight alloy. One function of filling is to enable circumferential compression of the staples in the attachment means. The volume of the filling may also be slightly different from the volume left between the arms of the staple, for example slightly greater to increase the said application of compression or to prevent direct contact between the staple and the wheel disk. The filling may be fixed rigidly to the staple, by gluing or any other method.

Alternately, the staple and the filling may both be composed of the same material, for example reinforced or unreinforced plastic. In this case, one attractive possibility is to mould the staple and the filling over the support element in a single operation.

Openings 18 can be formed in the arms of the staple. These openings can be used to introduce polymer 22 between the flexible strips (for example by injection, transfer, casting or other).

One preferred method for fabrication of a support element and for assembly with a staple comprises the following steps.

prepare the flexible strips 21,

arrange these flexible strips in a mould using the required arrangement in the support element,

place a staple straddling over the stack of flexible strips, in the required position relative to the support element,

introduce a liquid polymer that can, when in the solid state, form the intermediate layers 22 and fix the staple to the stack and possibly form the filling 19 and the swellings 13.

Carry out a solidification step on the assembly.

Solidification can be achieved in a known manner, for example by baking, cooling cross-linking, polymerisation.

FIG. 6 shows a partial sectional view of the disk and attachment means and a staple to show the embodiment in FIG. 2 in more detail. This view more clearly shows that the circumferential shoulder 9 actually forms a conical bearing surface 23. Similarly, the clamping ring 10 also comprises a conical bearing surface 24. These two conical surfaces 23 and 24 cooperate with the cylindrical bearing surface 15 to fix all staples 7 of the tire in place forming a dovetail shaped groove around the periphery of the disk 6. Preferably, an annular axial projection 27 of the clamping ring cooperates with an annular axial groove 28 of the disk 6 to resist at least some of the forces applied to the ring. A blocking means like an elastic ring 11 cooperates with a groove 20 to hold the clamping ring 10 in position in the axial direction.

The clamping ring 10 is preferably in a single piece and closed, although it could also be composed of several arcs, and spaces that are or are not left between the arcs. Similarly, the shoulder 9 could be cut in the disk or added onto the disk, and may be continuous or discontinuous. Preferably, the shoulder 9 is continuous (see FIG. 3) and forms a single piece with the disk as can be seen in FIG. 6.

Preferably, the radially outermost surfaces 25 and 26 of the shoulder 9 and the ring 10 form bearing surfaces for the support elements. This function is illustrated in FIG. 2. Refer to the description in patent application WO 00/037269 and particularly FIGS. 7 to 9 in this application for further information about possible dimensional variations of these bearing surfaces.

Remember that the radially inner part of the load bearing structure, i.e. the part closest to the wheel rotation axis makes an important contribution to the deflection under load, and therefore to the comfort provided by the tire. The attachment zone should preferably be located over a fraction corresponding to not more than 50% of the distance separating the side limits of the tire in the axial direction. The said inner part of the load bearing structure is thus significantly cantilevered beyond the attachment zone. One good construction arrangement is that the support elements just beyond the attachment zone are oriented along a direction essentially parallel to the rotation axis. This is shown in the example described. Finally, note that since the described tire is symmetric, the attachment zone is essentially centred between the axial limits of the said tire, although this is not limitative. Obviously, an asymmetric architecture could be adopted, particularly in the location of the attachment zone.

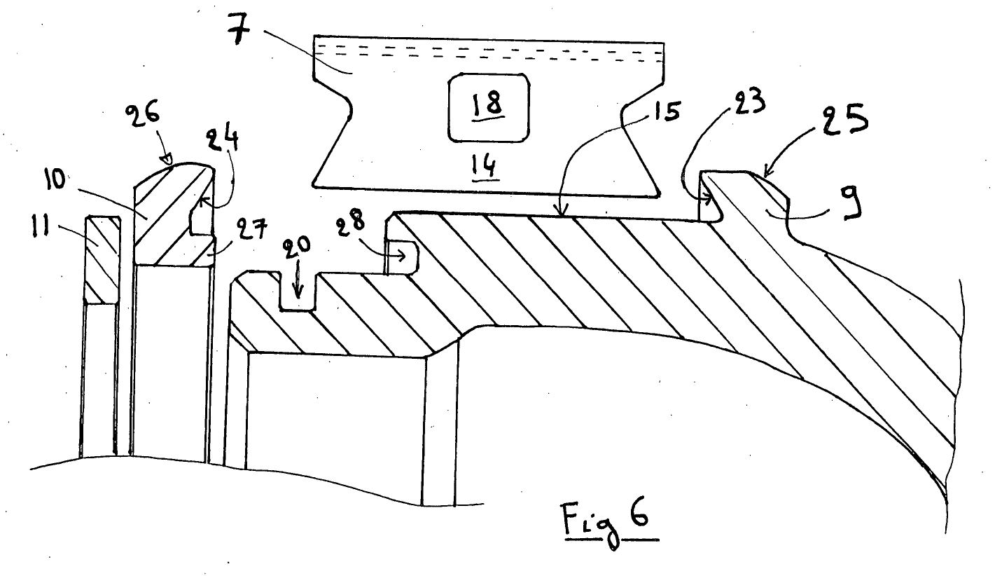

According to one variant of the invention, the support elements may also be open, in other words interrupted as shown in FIGS. 8 and 9 in patent application WO 00/037269 and in FIG. 1 in patent application EP 1 359 028. In this case, closing is achieved by the staple and the attachment means described above and, if applicable, by the staple connecting polymer.

1. Support element (2) for a flexible tire (1), the said tire comprising a plurality of support elements adjacent to each other circumferentially and distributed all around a rotation axis of the tire to form a load bearing structure, a tread (4) at the radially outside periphery of the load bearing structure, a staple (7) being fixed to the said support element and designed to cooperate with the wheel disk attachment means.

2. Support element (2) according to claim 1, in which the staple (7) consists of a metal plate folded to match the shape of the attachment zone of the said support element.

3. Support element according to claim 1, comprising a stack of flexible strips (21) and layers (22) made of polymer composition.

4. Support element according to claim 3 in which the flexible strips have a closed ovoid shape.

5. Support element according to claim 4 in which the staple (7) is fixed rigidly to the said support element through the said polymer composition.

6. Support element according to claim 1 in which the staple (7) comprises two arms (16, 17) extending radially inwards, a filling (19) occupying the volume between the arms of the staple under the section of the support element.

7. Support element according to claim 1, in which the staple (7) comprises two arms (16, 17) extending radially inwards, the arms having a dovetail shape.

8. Flexible tire (1) comprising a plurality of support elements according to claim 1.

9. Flexible tire (1) with a flexible load bearing structure extending circumferentially around a rotation axis, a tread (4) at the periphery radially outside the load bearing structure, and at least one attachment zone (5) radially on the side of the rotation axis, to fix the said load bearing structure to a wheel disk (6), the load bearing structure comprising a plurality of support elements extending essentially in the transverse direction, in which at least a first part is arranged facing a part of the tread, and another part of which is arranged beyond the tread, the said support elements being adjacent to each other around the circumferential direction and distributed all around the circumference, each support element being fixed on the wheel disk by a staple (7), the said staple straddling the support element and being designed to cooperate with wheel disk attachment means (9, 10, 11).

10. Wheel disk (6) capable of connecting to a hub the tire (1) according to claim 8, the said disk comprising attachment means (9, 10, 11) capable of cooperating with a plurality of staples to fix a plurality of support elements.

11. Wheel disk (6) according to claim 10, in which the attachment means include a cylindrical bearing surface (15), a circumferential shoulder (9) and a tightening ring (10) capable of cooperating to form a dovetail-shaped groove around the periphery of the disk.

12. Support element according to claim 3 in which the staple (7) is fixed rigidly to the said support element through the said polymer composition.
